(19) United States
(12) Patent Application Publication
(10) Pub. No.: US 2018/0088418 A1
(43) Pub. Date: Mar. 29, 2018

(54) LENS PANEL AND DISPLAY DEVICE INCLUDING THE SAME

(71) Applicant: Samsung Display Co., Ltd, Yongin-si (KR)

(72) Inventors: Su Jung HUH, Yongin-si (KR); Hyung-Don NA, Seoul (KR); Keun Kyu SONG, Seongnam-si (KR); Joo Woan CHO, Seongnam-si (KR)

(21) Appl. No.: 15/492,794

(22) Filed: Apr. 20, 2017

(30) Foreign Application Priority Data
Sep. 23, 2016 (KR) 10-2016-0122437

(51) Int. Cl. G02F 1/1343; G02F 1/1337

(52) U.S. Cl. CPC G02F 1/134336; G02F 1/1337

(57) ABSTRACT

The present disclosure relates to a lens panel and a display device including the same, and the lens panel according to an exemplary embodiment includes a region divided into a plurality of domains in a plan view, wherein the region divided into the plurality of domains includes an optical modulation layer, and a first electrode and a second electrode facing each other with the optical modulation layer interposed therebetween in a sectional view, at least one of the first electrode and the second electrode has a plurality of main openings, at least one of the first electrode and the second electrode has a plurality of sub-openings, the main openings are positioned one by one in each of the plurality of domains in the plan view, the sub-opening is positioned on a boundary between the adjacent domains, and a planar area of the sub-opening is smaller than a planar area of the main opening.

### CROSS-REFERENCE TO RELATED APPLICATION

This application claims priority to and the benefit of Korean Patent Application No. 10-2016-0122437 filed in the Korean Intellectual Property Office on Sep. 23, 2016, the entire contents of which are incorporated herein by reference.

### BACKGROUND

### (a) Technical Field

The present disclosure relates to a lens panel and a display device including the same, and in detail, relates to a lens panel capable of being switched and a display device including the same.

### (b) Description of the Related Art

Three-dimensional (3D) image display devices have attracted attention in the development of display device techniques, and various 3D image display devices have been researched.

A three-dimensional image may be displayed using binocular disparity as the largest factor for perceiving three-dimensions in the display technique of the 3D image. The 3D image display device may be classified into those using various methods, and may be largely classified as a stereoscopic 3D image display device or an autostereoscopic 3D image display device. In a case of the stereoscopic 3D image display device, there is a drawback that spectacles must be worn such that further development of the stereoscopic 3D image display device is required.

The autostereoscopic 3D image display device may be classified as those using a multi-viewpoint method or a super multi-viewpoint method in which the 3D image may be observed without the spectacles in a specific viewing angle region, and an integrated image method, a volume image method, and a hologram method that provide the 3D image to be closer to actual 3D reality. Among them, the multi-viewpoint method may be classified as a spatial division method of spatially dividing an entire resolution to realize a required viewpoint number by using a lens array, or a temporal division method of temporally and quickly displaying several viewpoint images while maintaining the entire resolution. In the integrated image method, a basic image, as an image in which 3D image information is photographed with a limited size in slightly different directions, is stored and then is shown through a lens array, thereby allowing the 3D image to be perceived by the observer.

The autostereoscopic 3D image display device includes an optical modulation unit to control a path of light, and the lens array is mainly used as the optical modulation unit. A panel capable of forming the lens array is referred to as a lens panel.

The above information disclosed in this Background section is only for enhancement of understanding of the background of the invention and therefore it may contain information that does not form the prior art that is already known in this country to a person of ordinary skill in the art.

### SUMMARY

An exemplary embodiment of the present disclosure increases a control force for an inclination direction of liquid crystal molecules in a lens panel including the liquid crystal molecule to improve a characteristic of the lens panel.

An exemplary embodiment improves the characteristics of the 3D image displayed by using the lens panel through the characteristic improvement of the lens formed in the lens panel.

A lens panel according to an exemplary embodiment includes a region divided into a plurality of domains in a plan view, wherein the region divided into the plurality of domains includes an optical modulation layer, and a first electrode and a second electrode facing each other with the optical modulation layer interposed therebetween in a sectional view, at least one of the first electrode and the second electrode has a plurality of main openings, at least one of the first electrode and the second electrode has a plurality of sub-openings, each of the plurality of main openings is positioned in each respective domain of the plurality of domains in the plan view, a sub-opening of the plurality of sub-openings is positioned on a boundary between adjacent domains of the plurality of domains, and a planar area of the sub-opening is smaller than a planar area of the main opening.

A display device according to an exemplary embodiment includes: a display panel including a plurality of pixels; and a lens panel positioned at a side of the display panel, wherein the lens panel includes a region divided into a plurality of domains in a plan view, the region divided into the plurality of domains includes an optical modulation layer, and a first electrode and a second electrode facing each other with the optical modulation layer interposed therebetween in a sectional view, the first electrode has a plurality of main openings, at least one of the first electrode and the second electrode has a plurality of sub-openings, in the plan view, the main openings are is positioned one by one in each of the plurality of domains, the sub-opening is positioned on a boundary between adjacent domains, and a planar area of the sub-opening is smaller than a planar area of the main opening.

The sub-opening may have a center positioned at a vertex shared by the adjacent domains.

The sub-opening may be positioned at a center point of a region between the main openings positioned in the adjacent domains, and distances from the center point to each center of the adjacent domains may be approximately equal to each other.

The sub-opening may be positioned at a center of an imaginary polygon having vertices located at the centers of the adjacent domains.

A width in a first direction of the sub-opening may be approximately 5% or less than the width in the first direction of the domain.

Two domains sharing one side may be adjacent domains.

A shape of each domain of the plurality of domains may be a polygon, and a shape of at least one of the main opening and the sub-opening may be one among a circle, an oval, and a polygon.

The optical modulation layer may include a plurality of liquid crystal molecules.

At least one alignment layer positioned between at least one of the first electrode and the second electrode, and the optical modulation layer, may be further included.

The plurality of main openings may be only positioned in the first electrode.

In the plan view, each of the plurality of domains may overlap two or more pixels.

The plurality of pixels may be arranged in a matrix shape, and the plurality of domains may be arranged in a direction that is oblique to a row direction or a column direction in which the plurality of pixels are arranged.

According to an exemplary embodiment of the present disclosure, in the lens panel including the liquid crystal molecules, the control force for the inclination direction of the liquid crystal molecules increases such that the characteristics of the lens panel may be improved, and the characteristics of the 3D image displayed by using the lens panel may be improved through the characteristic improvement of the lens.

### BRIEF DESCRIPTION OF THE DRAWINGS

FIG. 1 is a top plan view of a lens panel according to an exemplary embodiment,

FIG. 2 is a top plan view of one electrode unit included in a lens panel shown in FIG. 1,

FIG. 3 is a top plan view of the other electrode unit included in a lens panel shown in FIG. 1,

FIG. 4 is a cross-sectional view of a lens panel of FIG. 1 taken along a line A-AI in a first mode according to an exemplary embodiment,

FIG. 5 is a cross-sectional view of a lens panel of FIG. 1 taken along a line A-AI in a second mode according to an exemplary embodiment,

FIG. 6 is a cross-sectional view of a lens panel of FIG. 1 taken along a line B-BI in a first mode according to an exemplary embodiment,

FIG. 7, FIG. 8, and FIG. 9 are simulation results showing a characteristic of a lens when forming the lens through a lens panel according to a comparative example,

FIG. 10 is a simulation result showing a characteristic of a lens when forming the lens through a lens panel according to an exemplary embodiment,

FIG. 11 is a top plan view of one electrode unit included in a lens panel according to an exemplary embodiment,

FIG. 12 is a top plan view of one electrode unit included in a lens panel according to an exemplary embodiment,

FIG. 13 and FIG. 14 are top plan views of a lens panel according to an exemplary embodiment,

FIG. 15 is a top plan view of one electrode unit included in a lens panel shown in FIG. 14,

FIG. 16 is a top plan view of the other electrode unit included in a lens panel shown in FIG. 14,

FIG. 17 is a cross-sectional view of a lens panel of FIG. 14 taken along a line C-CI in a first mode according to an exemplary embodiment,

FIG. 18 is a cross-sectional view of a lens panel of FIG. 14 taken along a line C-CI in a second mode according to an exemplary embodiment,

FIG. 19 is a cross-sectional view of a lens panel of FIG. 14 taken along a line D-DI in a second mode according to an exemplary embodiment,

FIG. 20 is a view schematically illustrating a method of displaying an image at one viewpoint region through a display device including a lens panel according to an exemplary embodiment,

FIG. 21 is a view showing a method of displaying an image at several viewpoint regions through a display device including a lens panel according to an exemplary embodiment in a cross-sectional view of the display device,

FIG. 22 is a view showing a method of displaying a 2D image through a display device including a lens panel according to an exemplary embodiment in a cross-sectional view of the display device, and

FIG. 23 is a top plan view of a display device including a lens panel according to an exemplary embodiment.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clearly explain the present invention, portions that are not directly related to the present invention are omitted, and the same reference numerals are attached to the same or similar constituent elements through the entire specification.

In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity. In the drawings, for better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

In all of the specification and drawings, a view or a structure on a surface parallel to a first direction DR1 and a second direction DR2 crossing each other is referred to as “in a plan view” (or when viewed on a plane) and “in a plan structure”. When a direction perpendicular to the first direction DR1 and the second direction DR2 is referred to as a third direction DR3, a view or a structure on a surface parallel to one direction of the first direction DR1 and the second direction DR2, and the third direction DR3, is referred to as “in a sectional view” (or when viewed on a cross-section) and “in a sectional structure”.

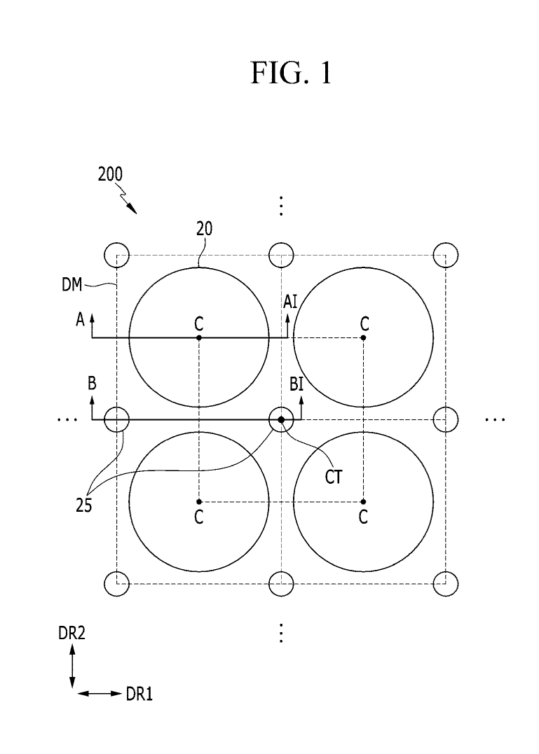

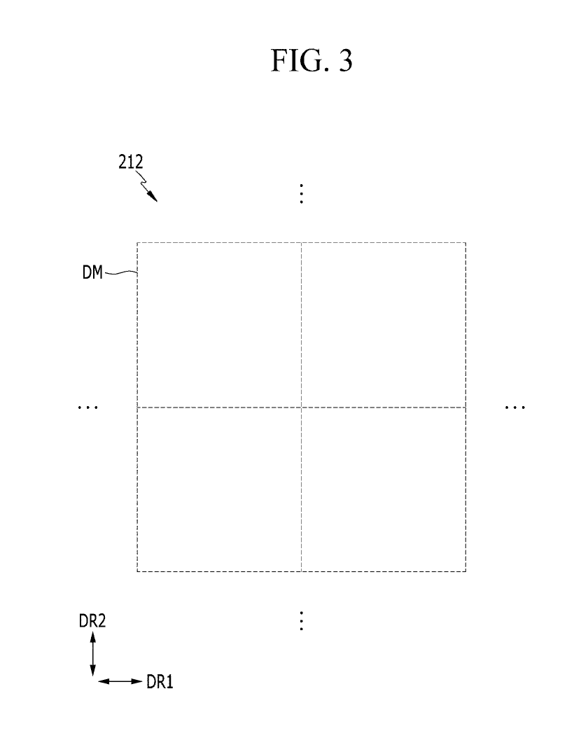

Now, a lens panel according to an exemplary embodiment will be described with reference to FIG. 1 to FIG. 10.

First, referring to FIG. 1 to FIG. 6, a lens panel 200 according to an exemplary embodiment includes a first electrode unit 210 and a second electrode unit 220 facing each other in a sectional view, and an optical modulation layer 230 positioned between the first electrode unit 210 and the second electrode unit 220. The lens panel 200 may be an extending shape in a plane parallel to the first direction DR1 and the second direction DR2, however it is not limited thereto, and the lens panel 200 may be a curved surface of which a curvature is larger than 0 may be formed. The shape of the lens panel 200 may be changed depending on a method or a kind of a 3D image display device using the lens panel.

In a plan view, a partial or entire region of the lens panel 200 may be divided into a plurality of domains DM. A shape of one domain DM may be one among various polygons, and particularly, may be a convex polygon of which all inner angles are smaller than 180 degrees. For example, the shape of one domain DM may be a quadrangle as shown, however the shape is not limited thereto, and the shape may be pentagonal, hexagonal, and the like. When one domain DM is an n square (n is a natural number of 3 or more), one domain DM may be adjacent to around n domains DM, and two adjacent domains DM may share one side and may be adjacent.

Lengths of the sides of one domain DM are the same as each other as shown such that the domain may be a regular polygon, however the lengths of the sides are not limited thereto, and the sides thereof may have different lengths from each other. That is, the length in one direction in a plan view of one domain DM may be longer than the length in another direction.

A size and a shape of a plurality of domains DM included in the lens panel 200 may be constant, however it is not limited thereto, and the lens panel may include domains DM of different shapes from each other depending on positions. Also, the shape of the domains DM is not limited to the polygon and the domains may have an irregular shape. In this case, the shape of the plurality of domains DM included in the lens panel 200 may not be constant depending on the positions.

As shown, the plurality of domains DM may be arranged in a matrix shape. However, the domains DM may not be aligned in at least one of a row direction or a column direction.

The first electrode unit 210 and the second electrode unit 220 may respectively have a plate or film shape having a main surface mainly extending in a surface parallel to the first direction DR1 and the second direction DR2, however they are not limited thereto, and they may have a plate or film shape formed in a curved surface.

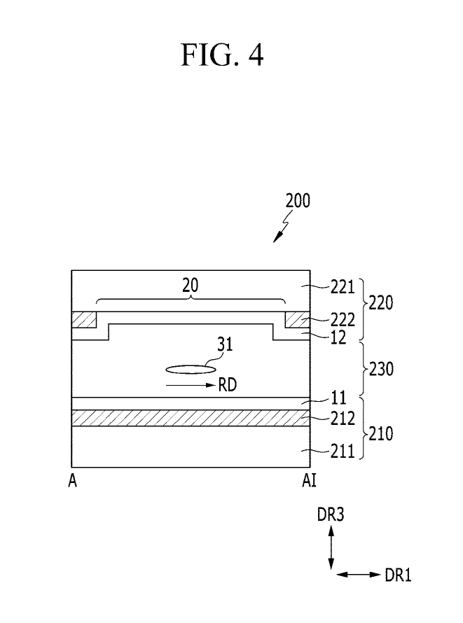

Referring to FIG. 4 to FIG. 6, the first electrode unit 210 includes a first substrate 211 and at least one first electrode 212, and the second electrode unit 220 includes a second substrate 221 and at least one second electrode 222. The first electrode 212 and the second electrode 222 may face each other with an optical modulation layer 230 interposed therebetween. In the present exemplary embodiment, a structure in which the first electrode unit 210 includes one first electrode 212 and the second electrode unit 220 includes one second electrode 222 is mainly described.

At least one of the first electrode 212 and the second electrode 222 has a plurality of main openings and sub-openings. The openings are regions where the electrode is removed in a plan view.

In the present exemplary embodiment, the second electrode 222 has a plurality of main openings 20 and a plurality of sub-openings 25 and the first electrode 212 does not have the main openings or the sub-openings, but they are not limited thereto. That is, instead of the second electrode 222, the first electrode 212 may have a plurality of main openings (not shown) and a plurality of sub-openings (not shown), the main openings may be positioned in one of the first electrode 212 or the second electrode 222 and the sub-openings may be positioned in the other, or a plurality of main openings and a plurality of sub-openings may be formed in all of the first electrode 212 and the second electrode 222, thereby various configurations are possible.

When a plurality of main openings are formed in all of the first electrode 212 and the second electrode 222, in a plan view, in one domain DM, only one of the main opening of the first electrode 212 and the main opening of the second electrode 222 may be formed.

When a plurality of sub-openings are formed in both of the first electrode 212 and the second electrode 222, in a plan view, only one of sub-openings of the first electrode 212 and sub-openings of the second electrode 222 may be formed where the sub-openings are positioned, or the sub-openings of the first electrode 212 and the sub-openings of the second electrode 222 are positioned to be overlapped with each other.

Each shape of the main opening 20 and the sub-opening 25 may be one among various shapes. For example, as shown, the shape of the main opening 20 and the sub-opening 25 may be a circular, however it is not limited thereto, and the shape may be oval or polygonal. Particularly, when the shape of the main opening 20 is polygonal, the shape may be a convex polygon of which all inner angles are smaller than 180 degrees.

A width in any one direction of the main opening 20 may be 100 micrometers or less, but it is not limited thereto. The width of the main opening 20 may be substantially the same in all directions, however it is not limited thereto, and the length in one direction may be longer than the length in another direction.

As the resolution of lens panel 200 increases, a size of the main opening 20 may decrease. The shape of the main openings 20 may be constant depending on the positions in the lens panel 200, however it is not limited thereto, and the main openings may have different shapes from each other.

One main opening 20 is positioned in each domain DM. In a plan view, a center C of each domain DM may approximately coincide with the center of the main opening 20. Here, each center C of the respective domains DM may be the mass center of the respective domains DM, however it is not limited thereto, and the center C may be various centers such as a crossing point of two or more lines that becomes a symmetric reference of the shape of the domains DM. Hereafter, the center of the domains DM and the center of the main openings 20 are all indicated by “C”.

The region of the main opening 20 may be limited to the inside of each domain DM, but it is not limited thereto. For example, in a plan view, a ratio of an area of the part that the main opening 20 occupies with each domain DM for the area of the domain DM may be about 50% or more.

The sub-opening 25 is positioned in a region that does not overlap the main opening 20 in a plan view, and particularly, may be positioned at a boundary between adjacent domains DM or in the vicinity thereof. The center of the sub-opening 25 may be positioned at a vertex that is shared by at least two domains DM of the plurality of adjacent domains DM. In detail, the sub-opening 25 may be approximately positioned at a center point CT of an electrode region between the plurality of adjacent main openings 20. Distances from the center C of the plurality of domains DM adjacent to the center point CT to the center point CT may be approximately equal to each other. As shown in FIG. 1, when forming an imaginary polygon having vertices located at the centers C by connecting an imaginary line between the centers C of the plurality of adjacent main opening 20 or domains DM, a center of the sub-opening 25 may be positioned at the approximately mass center of the polygon.

The center of the sub-opening 25 may match the approximate center point CT.

A planar area of the sub-opening 25 may be smaller than a planar area of the main opening 20. For example, a width in one direction of the sub-opening 25 may be approximately 10% or less of the width of one direction of one domain DM (a pitch in one direction of the domains DM).

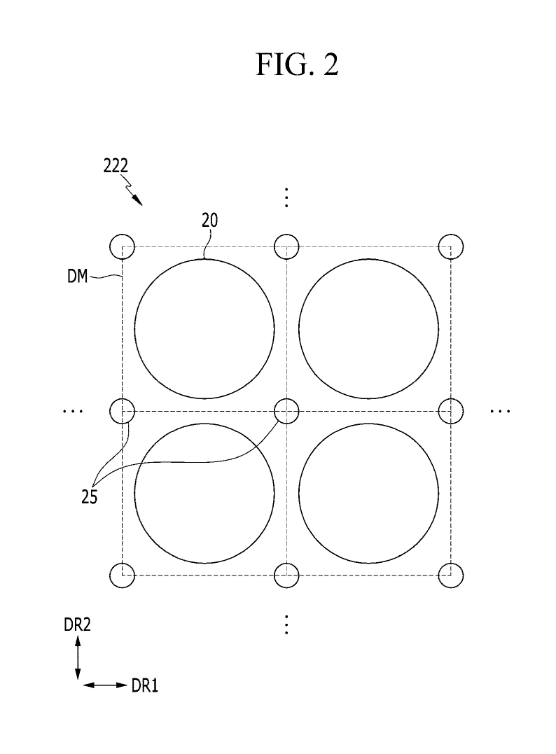

FIG. 1 and FIG. 2 show an example in which the sub-opening 25 is positioned at all centers of the regions between the adjacent domains DM, however it is not limited thereto, and the sub-opening 25 may not be positioned at a part among the regions between the adjacent domains DM.

At least one of the first substrate 211 and the second substrate 221 may be omitted depending on a method with which they are attached or formed to a device to which the lens panel 200 is applied.

The optical modulation layer 230 as a switchable optical modulation layer may control a phase of the transmitted light to control the path of the light. For example, the optical modulation layer 230 may be a liquid crystal layer including a plurality of anisotropic liquid crystal molecules 31. The liquid crystal molecules 31 may have positive dielectric anisotropy, but are not limited thereto. The width of the third direction DR3 of the optical modulation layer 230, that is, a gap between the first electrode unit 210 and the second electrode unit 220, may be in a range of about 3 micrometers to about 30 micrometers, however it is not limited thereto.

Referring to FIG. 4 to FIG. 6, the first electrode unit 210 may further include an alignment layer 11 and the second electrode unit 220 may further include an alignment layer 12. The alignment layers 11 and 12 may define an alignment direction of the liquid crystal molecules 31 and may be aligned in one direction RD on the entire lens panel 200. The alignment layers 11 and 12 according to an exemplary embodiment may be horizontal alignment layers, however they are not limited thereto, and they may be vertical alignment layers. The alignment layer 11 may be positioned between the first electrode 212 and the optical modulation layer 230, and the alignment layer 12 may be positioned between the second electrode 222 and the optical modulation layer 230. The alignment layers 11 and 12 may be formed by various methods such as a rubbing method and a photoalignment method.

The optical modulation layer 230 has a refractive index distribution that is changed depending on a difference between voltages applied to the first electrode 212 and the second electrode 222, thereby controlling the path of the light. The optical modulation layer 230 may be operated in a plurality of modes including a first mode and a second mode depending on the difference between voltages applied to the first electrode 212 and the second electrode 222.

Referring to FIG. 4, in the first mode, a first voltage difference may be applied between the first electrode 212 and the second electrode 222. The first voltage difference, for example, may be a minimum voltage difference (e.g. 0 V). In the first mode, the arrangement direction of the liquid crystal molecules 31 in each domain DM, that is, the direction of a long axis of the liquid crystal molecules 31, may be constant. For example, in the first mode, as shown in FIG. 4, the liquid crystal molecules 31 are arranged such that the long axis thereof may be aligned to be approximately parallel to one direction RD in which the alignment layers 11 and 12 are aligned, or may be aligned to be approximately parallel to the main surface of the first electrode unit 210 or the second electrode unit 220. However, in the first mode, the liquid crystal molecules 31 may be arranged such that the long axis thereof may be aligned to be approximately perpendicular to the main surface of the first electrode unit 210 or the second electrode unit 220.

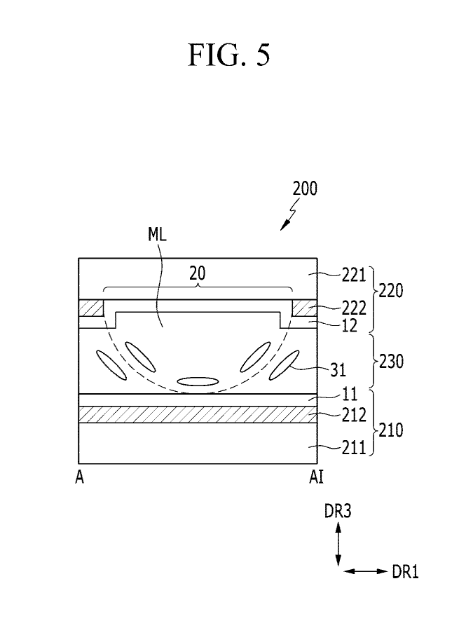

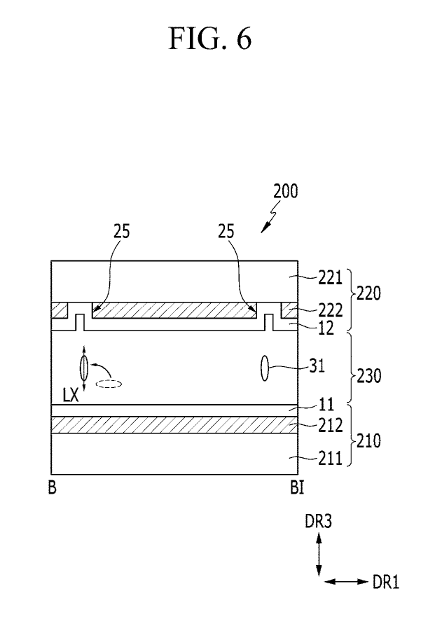

Referring to FIG. 5 and FIG. 6, in the second mode, an appropriate voltage difference (e.g., approximately 3.5 V to approximately 4 V) is applied between the first electrode 212 and the second electrode 222, and a main electrode field having a component of approximately the third direction DR3 is formed to the optical modulation layer 230, thereby the liquid crystal molecules 31 are rearranged. When the liquid crystal molecules 31 have positive dielectric anisotropy, the liquid crystal molecules 31 are rearranged such that the long axis thereof are aligned in the direction approximately parallel to the electric field direction.

Particularly, in each of the domains DM, the liquid crystal molecules 31 tend to be inclined in a certain direction by a fringe field between the second electrode 222 and the first electrode 212 near the edge of the main opening 20 and the sub-opening 25.

Referring to FIG. 5, in each domain DM, the liquid crystal molecules 31 corresponding to the main opening 20 are inclined at different angles depending on the position in the domain DM. Accordingly, the optical modulation layer 230 forms different refractive index distributions depending on the position in domains DM, thereby the light may experience different phase retardation depending on the position in the domains DM. In detail, the liquid crystal molecules 31 positioned near the center C of the domains DM are arranged to be approximately parallel to the main surface of the first electrode unit 210 or the second electrode unit 220, and the liquid crystal molecules 31 positioned near the edge of the domains DM may be inclined approximately toward the center of the domain DM. An inclination of the liquid crystal molecules 31 corresponding to the main opening 20 may increase closer to the edge of the domain DM based on the main surface of the first electrode unit 210 or the second electrode unit 220.

Accordingly, in each domain DM, the shape in which the liquid crystal molecules 31 corresponding to the main opening 20 are arranged is similar to the approximate planar convex lens, and the optical modulation layer 230 in each of the domains DM forms a lens ML that may control the light path. Each lens ML may be a micrometer lens that may refract the light in the viewing angle of all directions, differently from the lenticular lens, and the lens panel 200 forms a microlens array.

In a plan view, the lens ML may be mainly formed in the region corresponding to the main opening 20.

Referring to FIG. 6, the size of the sub-opening 25 is small such that the component of the first direction DR1 or the second direction DR2 is very small, and most of the component parallel to the third direction DR3 may be reinforced for the fringe field by the second electrode 222 near the edge of the sub-opening 25 in the second mode. Accordingly, the liquid crystal molecules 31 corresponding to the sub-openings 25 do not substantially form the lens, and as shown in FIG. 6, the liquid crystal molecules 31 are rearranged such that the long axis LX of the liquid crystal molecules 31 is aligned to be approximately parallel to the direction perpendicular to the main surface of the first electrode unit 210 or the second electrode unit 220, that is, the third direction DR3. However, the liquid crystal molecules 31 of which the long axis LX direction is slightly inclined from the third direction DR3 may exist near the sub-opening 25.

Accordingly, the direction of the liquid crystal molecule 31 around the sub-opening 25 positioned between the adjacent main openings 20 in the second mode may be controlled in the predetermined direction (e.g., the third direction DR3) without disorder. As above-described, since a control force for the inclination direction of the liquid crystal molecules 31 increases in the boundary region between the domains DM, the direction of the liquid crystal molecules 31 is not controlled by several factors and a non-uniform disclination region may be prevented, and crosstalk due to light leakage may be prevented from being generated in the region between the adjacent lenses ML. Also, since the direction of the liquid crystal molecules 31 is also controlled in the region where the lens ML is not formed, the disclination of the shape of the lens ML formed corresponding to the main opening 20, which causes defects, may be prevented, thereby improving the characteristic of the lens ML.

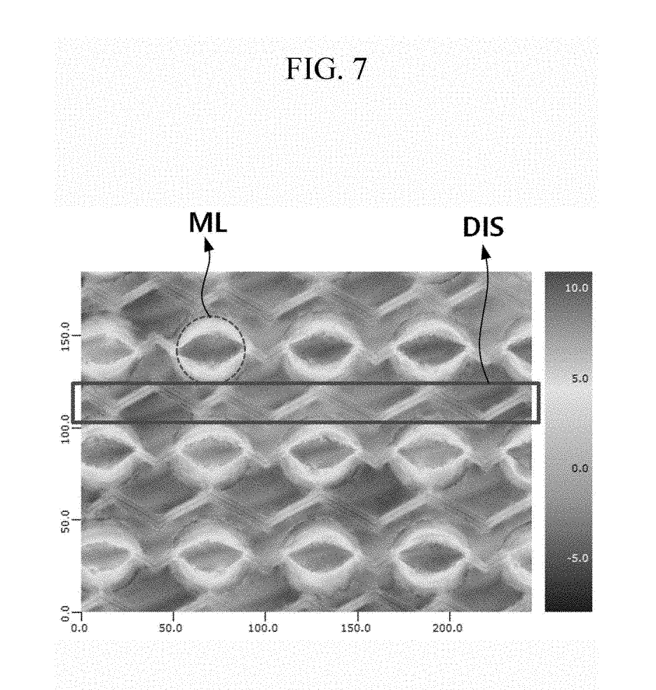

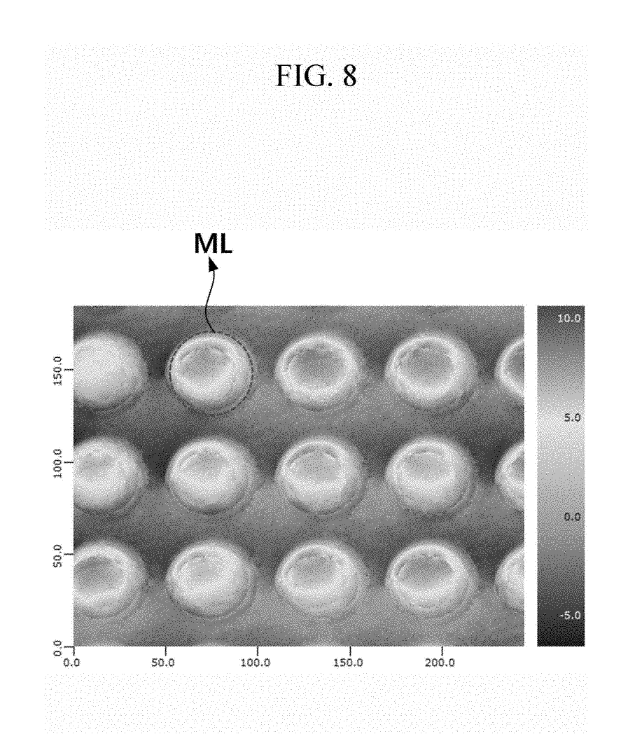

This will be described in detail with reference to FIG. 7 to FIG. 10.

FIG. 7 is a simulation result showing a characteristic of a lens when a lens panel forms a lens ML according to a comparative example, and particularly, it relates to the lens panel including the alignment layer formed by a photoalignment method. Referring to FIG. 7, the direction of the liquid crystal molecules is not controlled between the adjacent lenses ML and the disordered disclination region DIS is formed, thereby confirming the light leakage. The adjacent lens ML is distorted without having a rounded shape by the influence of the disclination region DIS.

FIG. 8 is a simulation result showing a characteristic of a lens when a lens panel forms a lens ML according to a comparative example, and particularly, it relates to the lens panel including the alignment layer formed by a rubbing alignment method. Since a rubbing direction for the alignment layer is one direction for a plurality of domains, the liquid crystal molecules have a pretilt in one direction such that it may be confirmed that asymmetry is generated in the shape of the lens ML. Also, between the adjacent lenses ML, although the liquid crystal molecules must be arranged in the direction perpendicular to the surface of the panel, it may be confirmed that the inclined state is formed by the fringe influence such that the light is leaked.

As another comparative example, referring to FIG. 9, a similar simulation result to that of above-described FIG. 7 is shown. In FIG. 9, it may also be confirmed that the direction of the liquid crystal molecules is not controlled between the adjacent lenses ML and the disordered disclination region DIS is formed, so the lens ML around the disclination region DIS loses the symmetry by the influence of the disclination region DIS and the distorted shape appears.

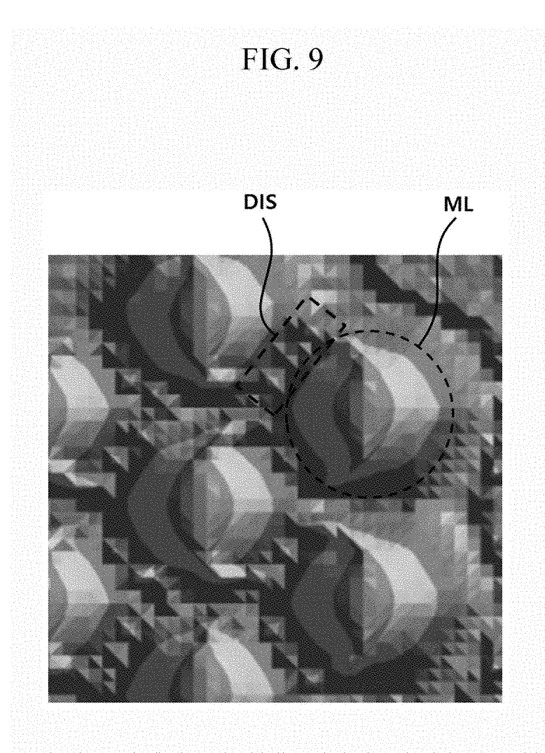

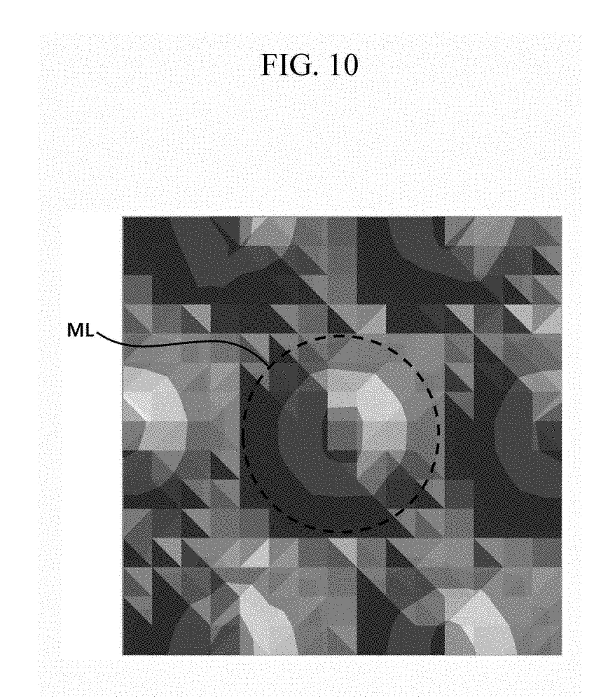

In comparison, referring to the simulation result of the lens ML formed by the lens panel according to an exemplary embodiment of the present invention with reference to FIG. 10, a color distribution between the adjacent lenses ML is mainly constant such that the disclination region disappears, so it may be confirmed that the shape of the lens ML is also symmetrical in all planar directions, thereby forming the perfect circle shape.

That is, as above-described, according to the exemplary embodiment of the present invention, the control force for the arrangement direction of the liquid crystal molecules 31 is improved by the sub-opening 25 formed in the region where the main opening 20 is not formed such that the disclination region between the lens ML disappears, so the normal state of the lens ML is maintained and the light leakage or the crosstalk between the lens LM may be prevented. Accordingly, the characteristic of the lens ML formed by the lens panel 200 may be improved.

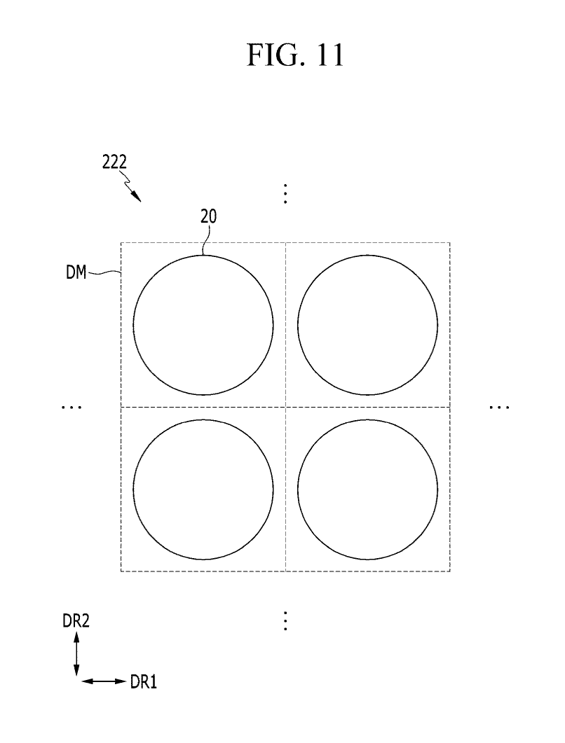

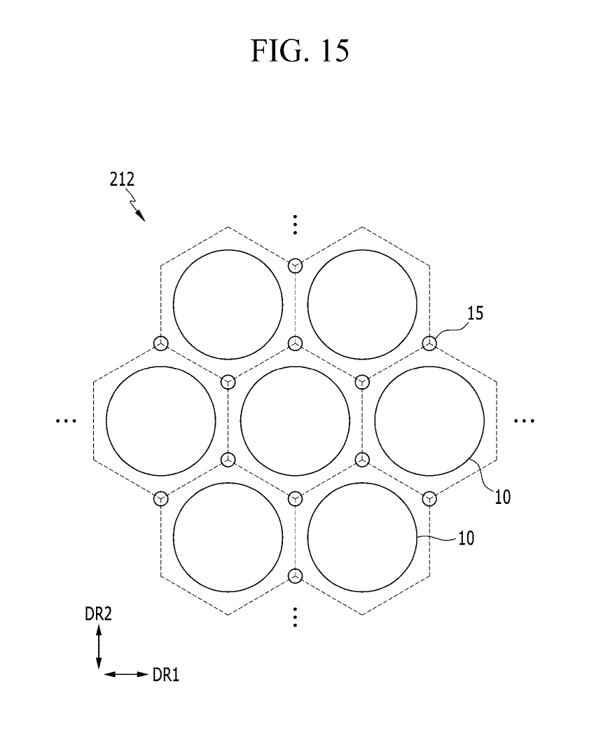

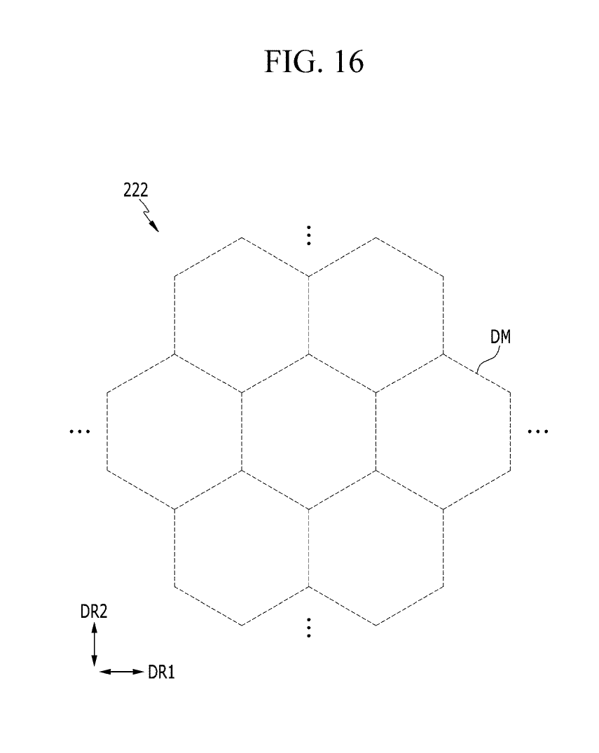

Next, the lens panel according to several exemplary embodiments will be described with reference to FIG. 11 to FIG. 19 as well as FIG. 1 to FIG. 10.

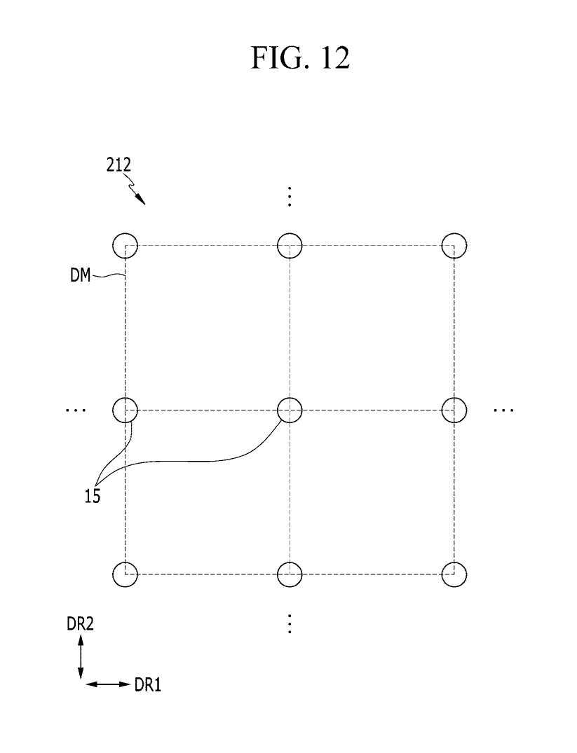

First, referring to FIG. 11 and FIG. 12, the lens panel according to the present exemplary embodiment is the same as most of the above-described exemplary embodiment, however the first electrode 212 may have a plurality of sub-openings 15 instead of the second electrode 222. In the first electrode 212, the planar position of the sub-opening 15 is the same as in the above-described exemplary embodiment such that the detailed description is omitted.

According to present exemplary embodiment, like the exemplary embodiment shown in FIG. 1 to FIG. 3, the second electrode 222 has the plurality of sub-openings 25, however the first electrode 212 may have the main opening (not shown).

According to present exemplary embodiment, like the exemplary embodiment shown in FIG. 1 to FIG. 3, the second electrode 222 may have the plurality of main openings 20 and the plurality of sub-openings 25, and the first electrode 212 may also further include an additional sub-opening (not shown) positioned corresponding to the sub-opening 25 of the second electrode 222.

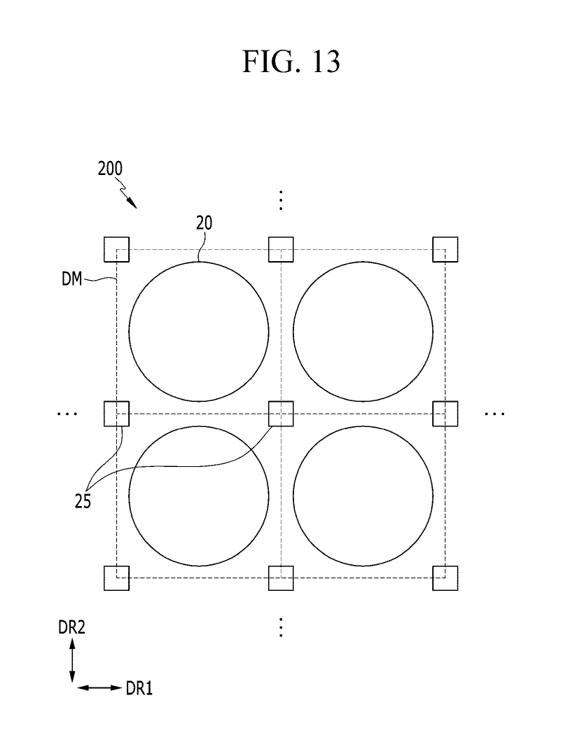

Next, referring to FIG. 13, the lens panel according to another exemplary embodiment is the same as most of the above-described exemplary embodiment, however the shape of the sub-opening 25 is a quadrangle rather than a circle. Other characteristics of the lens panel may be the same as described above.

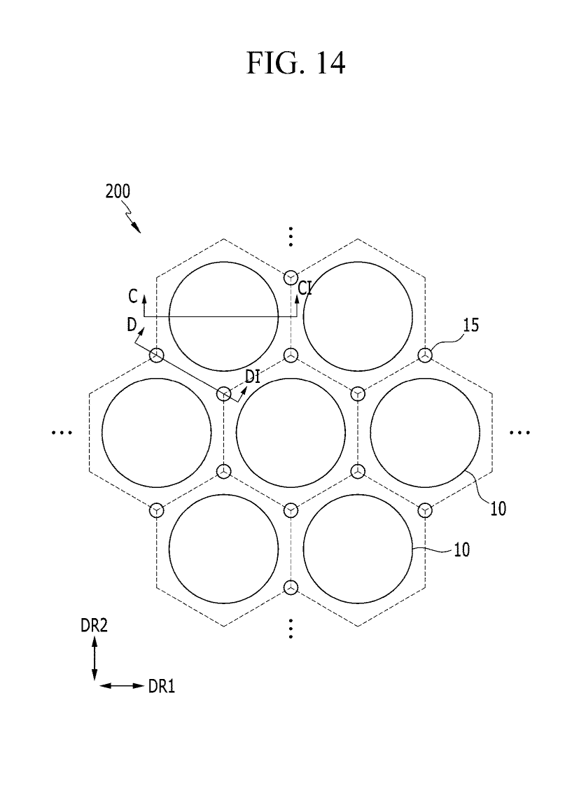

Next, referring to FIG. 14 to FIG. 19, the lens panel according to another exemplary embodiment may be mostly the same as in the above-described exemplary embodiment, however the shape of each domain DM is a hexagon rather than a quadrangle. Also, differently from the above-described exemplary embodiment, the first electrode 212 may have a plurality of main openings 10 and a plurality of sub-openings 15, and the second electrode 222 may not have the main openings or the sub-openings. Alternatively, the second electrode 222 may further include an additional sub-opening (not shown) at a position corresponding to the sub-opening 15 of the first electrode 212.

The shape and the position of the sub-opening 15 may be mostly the same as in the sub-opening in the above-described exemplary embodiment. In detail, the sub-opening 15 may be approximately disposed at the vertex shared with adjacent three domains DM. A shortest distance of the main opening 10 positioned in the adjacent domains DM to the center of the sub-opening 15 may be the same.

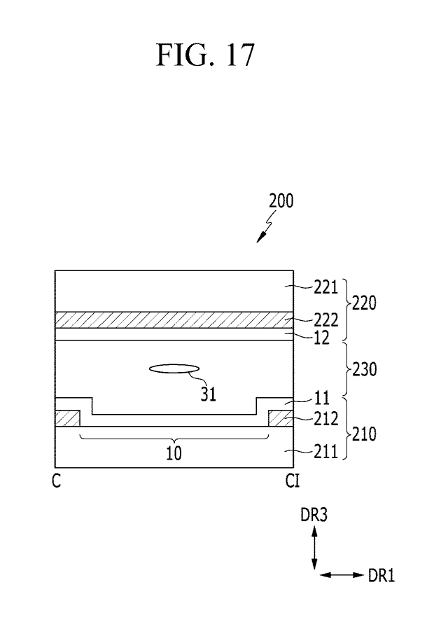

Referring to FIG. 17, if a first voltage difference is applied between the first electrode 212 and the second electrode 222 in the first mode, as described in FIG. 4, the liquid crystal molecules 31 may be arranged such that the long axis thereof may be aligned to be approximately parallel or perpendicular to the main surface of the first electrode unit 210 or the second electrode unit 220.

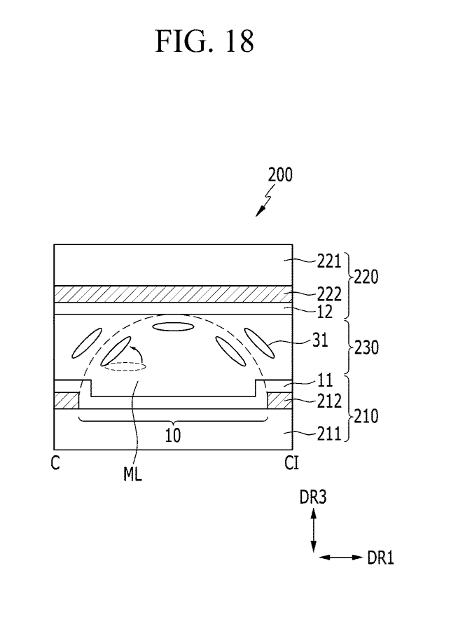

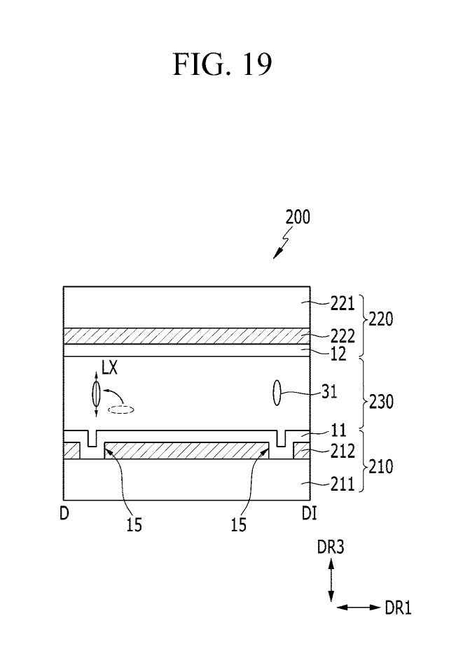

Referring to FIG. 18 and FIG. 19, if an appropriate voltage difference is applied between the first electrode 212 and the second electrode 222 in the second mode, the liquid crystal molecules 31 are rearranged by the main electric field and the fringe field generated to the optical modulation layer 230.

Referring to FIG. 18, the liquid crystal molecules 31 corresponding to the main opening 10 are inclined at different angles depending on the positions in the domains DM to be inclined with a similar shape to the planar convex lens, thereby forming the lens ML. The shape of the lens ML shown in FIG. 18 may have the opposite shape to the lens ML shown in FIG. 5 in the third direction DR3. Thus, the lens panel 200 forms a lens array.

Referring to FIG. 19, the liquid crystal molecules 31 near the sub-opening 15 in the second mode do not substantially form the lens, and the liquid crystal molecules 31 are rearranged such that the long axis LX thereof is aligned to be approximately parallel to the direction perpendicular to the main surface of the first electrode unit 210 or the second electrode unit 220, that is, the third direction DR3. However, the liquid crystal molecules 31 of which the direction long axis LX is slightly inclined from the third direction DR3 may exist near the sub-opening 15.

The effect according to the present exemplary embodiment is the same as described above such that the detailed description is omitted.

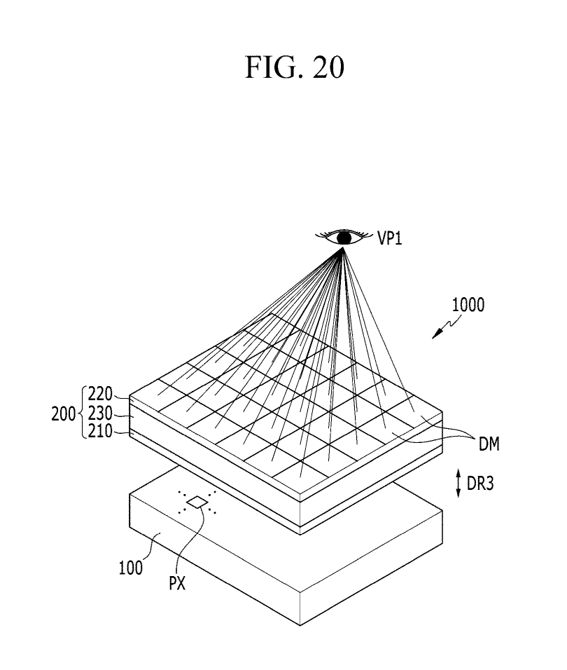

Next, a display device including the lens panel according to an exemplary embodiment will be described with reference to FIG. 20 to FIG. 23 as well as FIG. 1 to FIG. 19.

The display device 1000 according to an exemplary embodiment includes a display panel 100 and a lens panel 200 according to an exemplary embodiment. The structure of the lens panel 200 is the same as most of the lens panel according to the above-described several exemplary embodiments such that the detailed description is omitted.

The display panel 100 includes a plurality of pixels PX capable of displaying an image, and may output the image to a side of the lens panel 200. In a case of a high resolution display panel 100, the resolution of the pixel PX, for example, may be approximately 2250 ppi or more, but it is not limited thereto.

The display device 1000 may be various display devices such as a liquid crystal display, an organic light emitting diode display, and the like. In the case of the liquid crystal display, the display device 1000 may further include a backlight unit (not shown) providing light to the display panel 100.

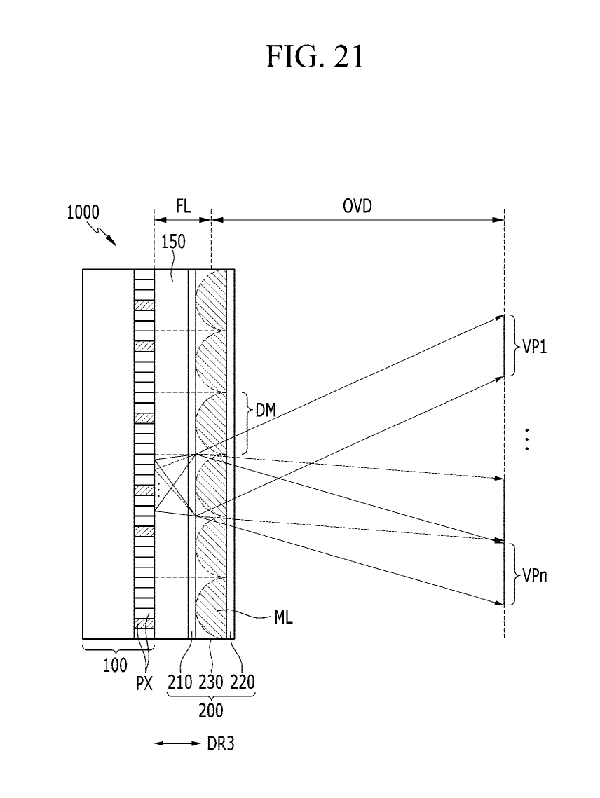

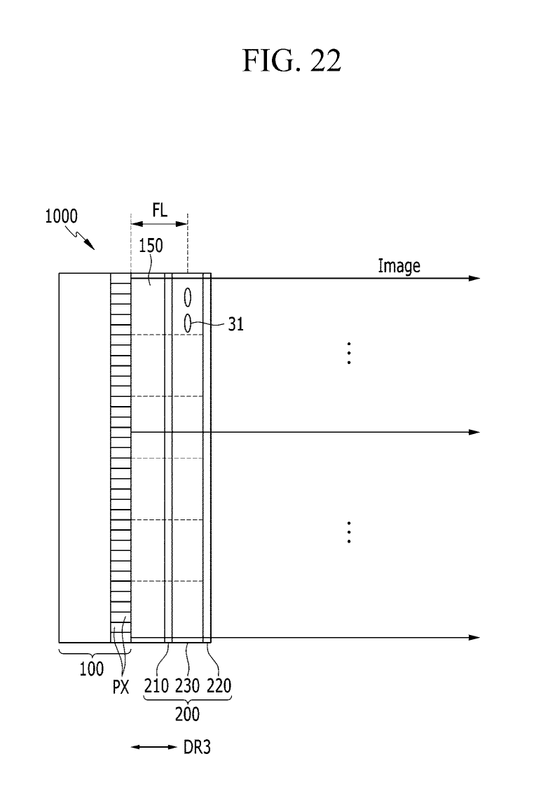

Referring to FIG. 21 and FIG. 22, a transparent adhesive member 150 fixing the display panel 100 and the lens panel 200 to each other may be positioned between the display panel 100 and the lens panel 200. The adhesive member 150, for example, may include an optical clear resin (OCR).

FIG. 20 and FIG. 21 show an operation method of a 3D mode in which the display device 1000 according to an exemplary embodiment is operated to observe different images from each other in a plurality of viewpoint regions VP1-VPn. In the 3D mode of the display device 1000, the lens panel 200 is operated with the above-described second mode such that the lens array including the plurality of lenses ML may be formed in the optical modulation layer 230. The display device 1000 may display the different images at a plurality of viewpoint regions VP1-VPn, thereby being referred to as a multi-viewpoint display device.

Referring to FIG. 21, a distance between the display surface where the image is displayed in the display panel 100 and the center on the sectional view of the lens ML formed in the lens panel 200 may be a focal length FL of the lens ML. A distance from the center on the sectional view of the lens ML formed in the lens panel 200 and a position capable of viewing an optimal stereoscopic image is referred to as an optimal viewing distance (OVD).

In the 3D mode, each pixel PX of the display panel 100 displays the image corresponding to any one of the viewpoint regions VP1-VPn, and the image displayed by each pixel PX may be observed at the corresponding viewpoint regions VP1-VPn through the lens panel 200 of the second mode. A left eye and a right eye of the viewer respectively recognize the images of the different viewpoint regions VP1-VPn from each other, thereby perceiving depth perception and stereoscopic perception.

Each domain DM of the lens panel 200 overlaps two or more pixels PX of the display panel 100 in a plan view, and the light of the image displayed by the pixel PX overlapping each domain DM may pass the corresponding domain DM. The light from the pixels PX corresponding to each domain DM may be refracted in different directions from each other depending on the position in the domain DM. That is, the pixels PX corresponding to each domain DM may display the images corresponding to the respective different viewpoint regions VP1-VPn, and the pixels PX corresponding to each domain DM may display the image corresponding to most of the viewpoint regions VP1-VPn.

Referring to FIG. 20, for example, the image of the pixel PX corresponding to the first viewpoint region VP1 among the images of the plurality of pixels PX incident to the plurality of domains DM may be observed in the first viewpoint region VP1 through the lens ML of each domain DM.

Referring to FIG. 21, the images of the plurality of pixels PX corresponding to one domain DM may be refracted in the different directions from each other through the position of the lens ML of the domain DM, and then may be observed in the respective different viewpoint regions VP1-VPn.

According to the present exemplary embodiment, the disclination region between the lenses ML formed by the lens panel 200 in the 3D mode is removed and the lens ML maintains the circular shape such that the characteristics of the lens ML may be improved, thereby the characteristics of the 3D image observed through the display device 1000 may be improved.

FIG. 22 shows the method in which the display device 1000 according to an exemplary embodiment is operated with a 2-dimensional mode. In the 2D mode, the lens panel 200 is operated with the above-described first mode such that the lens ML is not formed in the optical modulation layer 230 and the liquid crystal molecules 31 may be arranged in the same direction. That is, the lens panel 200 is turned off in the 2D mode such that the image displayed in the display panel 100 may be recognized as the 2D image as it is through the lens panel 200.

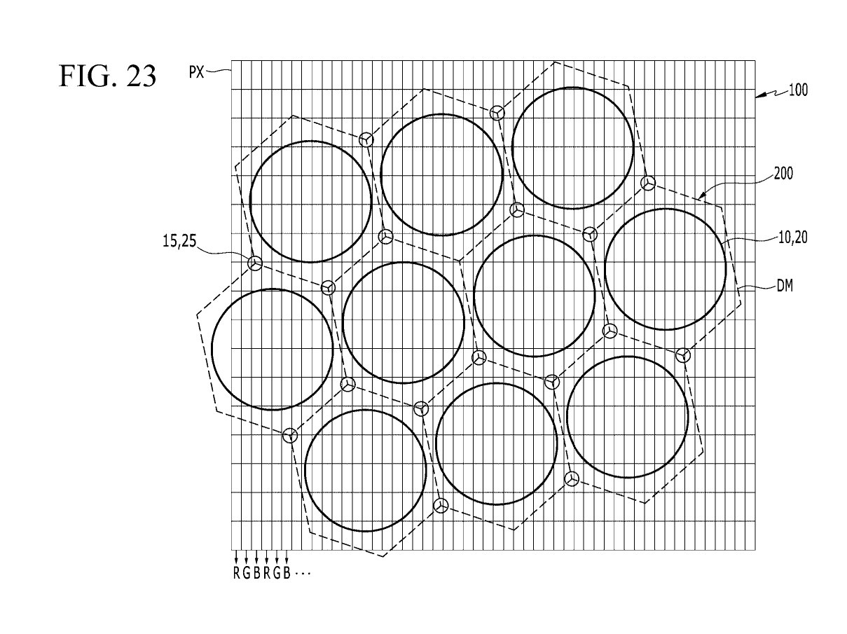

Next, an arrangement relationship of the lens panel and the display panel according to an exemplary embodiment will be described with reference to FIG. 23 as well as FIG. 20 to FIG. 22 as described above.

Referring to FIG. 23, one domain DM of the lens panel 200 according to an exemplary embodiment may overlap two or more pixels PX of the display panel 100 in a plan view, and FIG. 23 shows an example in which each domain DM overlaps approximately 65 (13×5) pixels PX. The plurality of pixels PX overlapping one domain DM may respectively correspond to the different viewpoint regions from each other. Accordingly, in the case of the exemplary embodiment shown in FIG. 23, the display device may display the image to be divided into approximately 65 viewpoint regions.

The pixels PX of the display panel 100 are disposed in a row and a column that are approximately parallel to the first direction DR1 and the second direction DR2 perpendicular to the first direction, thereby being arranged in a matrix shape. Each pixel PX may emit light of one color or a plurality of colors. For example, each pixel PX displays one color of red (R), green (G), and blue (B), the pixels PX positioned in one column represent the same color, and pixel PX columns of different colors may be alternately disposed. However, the arrangement of the pixels PX of the display panel 100 is not limited thereto.

FIG. 23 shows an example in which the lens panel 200 is the same as the exemplary embodiment shown in FIG. 14, however the structure of the lens panel 200 is not limited thereto, and it may have a structure according to the above-described various exemplary embodiments. For example, the shape of the domains DM may be quadrangular.

The domains DM of the lens panel 200 may be arranged in a direction that is obliquely inclined to the first direction DR1 and the second direction DR2.

The lens panel according to an exemplary embodiment of the present invention may be variously applied as needed to control the path of the light in various 3D display systems as well as the above-described display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10, 20: main opening | 15, 25: sub-opening |
| 31: liquid crystal molecule | |
| 100: display panel | 200: lens panel |
| 210: first electrode unit | 212: first electrode |
| 220: second electrode unit | 222: second electrode |
| 230: optical modulation layer | 1000: display device |

What is claimed is:

1. A lens panel comprising
a region divided into a plurality of domains in a plan view,
wherein the region divided into the plurality of domains includes an optical modulation layer, and a first electrode and a second electrode facing each other with the optical modulation layer interposed therebetween in a sectional view,
at least one of the first electrode and the second electrode has a plurality of main openings,
at least one of the first electrode and the second electrode has a plurality of sub-openings,
each of the plurality of main openings is positioned in each respective domain of the plurality of domains in the plan view,
a sub-opening of the plurality of sub-openings is positioned on a boundary between adjacent domains of the plurality of domains, and
a planar area of the sub-opening is smaller than a planar area of the main opening.

2. The lens panel of claim 1, wherein
the sub-opening has a center positioned at a vertex shared by the adjacent domains.

3. The lens panel of claim 1, wherein
the sub-opening is positioned at a center point of a region between the main openings positioned in the adjacent domains, and
distances from the center point to each center of the adjacent domains are approximately equal to each other.

4. The lens panel of claim 1, wherein
the sub-opening is positioned at a center of an imaginary polygon having vertices located at centers of the adjacent domains.

5. The lens panel of claim 1, wherein
a width in a first direction of the sub-opening is approximately 5% or less than a width in the first direction of the domain.

6. The lens panel of claim 1, wherein
two domains sharing one side are adjacent domains.

7. The lens panel of claim 6, wherein
a shape of each domain of the plurality of domains is a polygon, and
a shape of at least one of the main opening and the sub-opening is one among a circle, an oval, and a polygon.

8. The lens panel of claim 1, wherein
the optical modulation layer includes a plurality of liquid crystal molecules, and
at least one alignment layer positioned between at least one of the first electrode and the second electrode, and the optical modulation layer, is further included.

9. The lens panel of claim 1, wherein
the plurality of main openings are only positioned in the first electrode.

10. A display device comprising:
a display panel including a plurality of pixels; and
a lens panel positioned at a side of the display panel,
wherein the lens panel includes a region divided into a plurality of domains in a plan view,
the region divided into the plurality of domains includes an optical modulation layer, and a first electrode and a second electrode facing each other with the optical modulation layer interposed therebetween in a sectional view,
the first electrode has a plurality of main openings,
at least one of the first electrode and the second electrode has a plurality of sub-openings,
in the plan view, each of the plurality of main openings is positioned in each respective domain of the plurality of domains, and
a sub-opening of the plurality of sub-openings is positioned on a boundary between adjacent domains of the plurality of domains.

11. The display device of claim 10, wherein
in the plan view, each of the plurality of domains overlaps two or more pixels.

12. The display device of claim 11, wherein
the plurality of pixels are arranged in a matrix shape, and
the plurality of domains are arranged in a direction that is oblique to a row direction or a column direction in which the plurality of pixels are arranged.

13. The display device of claim 10, wherein
the sub-opening has a center positioned at a vertex shared by the adjacent domains.

14. The display device of claim 10, wherein
the sub-opening is positioned at a center point of a region between the main openings positioned in the adjacent domains, and
distances from the center point to each center of the adjacent domains are approximately equal to each other.

15. The display device of claim 10, wherein
the sub-opening is positioned at a center of an imaginary polygon having vertices located at centers of the adjacent domains.

16. The display device of claim 10, wherein
a width in a first direction of the sub-opening is approximately 5% or less than the width in the first direction of the domain.

17. The display device of claim 10, wherein
two domains sharing one side are adjacent domains.

18. The display device of claim 17, wherein
a shape of each domain of the plurality of domains is a polygon, and
a shape of at least one of the main opening and the sub-opening is one among a circle, an oval, and a polygon.

19. The display device of claim 10, wherein
the optical modulation layer includes a plurality of liquid crystal molecules, and
at least one alignment layer positioned between at least one of the first electrode and the second electrode, and the optical modulation layer, is further included.

20. The display device of claim 10, wherein
a planar area of the sub-opening is smaller than a planar area of a main opening of the plurality of main openings.
